(19) United States
(12) Patent Application Publication
(10) Pub. No.: US 2008/0308078 A1
(43) Pub. Date: Dec. 18, 2008

(54) Engine having supercharging device

(76) Inventor: Yu Ling Theng, Changhua (TW)

Correspondence Address: CHARLES E. BAXLEY, ESQUIRE, 90 JOHN STREET, SUITE 309, NEW YORK, NY, 10038, US

(21) Appl. No.: 11/811,734

(22) Filed: Jun. 12, 2007

(51) Int. Cl. F02B 33/00

(52) U.S. Cl. 123/559.1

(57) ABSTRACT

An engine includes a cylinder having a spindle and a pulley attached to the spindle, a supercharger includes a receptacle having an air intake port, a gear rotatably supported in the receptacle with a shaft, another pulley attached to the shaft, and a coupling member engaged with the pulleys for allowing the gear to be rotated and driven by the spindle, and a turbine is rotatably supported in the receptacle with an axle and aligned with the air intake port of the receptacle, and coupled to the gear for allowing the turbine to be driven by the gear and to draw an air from ambient into the air intake port and into the cylinder and for supercharging the intake air to increase the fuel consumption effect.

### BACKGROUND OF THE INVENTION

1. Field of the Invention

The present invention relates to an engine, and more particularly to an engine including a supercharging device for supercharging the intake air and for supplying or introducing the supercharged air into the engine in order to increase the fuel consumption effect and thus to increase the operating effect for the engine.

2. Description of the Prior Art

Typical engines comprise a piston movable in an engine cylinder to vary the volume of a combustion chamber, an exhaust system removing combustion gases from the cylinder, a supercharger and an air supply system having dual intake ports, aspirated air intake port and charged air intake port for supplying the supercharged air into the combustion chamber of the engine cylinder.

For example, U.S. Pat. No. 6,470,681 to Orton discloses one of the typical engines comprising a supercharger and an air supply system having a turbine propelled by the exhausted gases discharged from the combustion chamber of the engine cylinder, and having a compressor driven by the turbine for supercharging the intake air and for supplying the supercharged air into the combustion chamber of the engine cylinder.

However, it will be difficult and complicated to couple and to supply the exhausted gases discharged from the combustion chamber of the engine cylinder to propel the turbine, in addition, the compressor may not be driven by the turbine in a reduced rotational speed.

The present invention has arisen to mitigate and/or obviate the afore-described disadvantages of the conventional supercharging devices for engines.

### SUMMARY OF THE INVENTION

The primary objective of the present invention is to provide an engine including a supercharging device for supercharging the intake air and for supplying or introducing the supercharged air into the engine in order to increase the fuel consumption effect and thus to increase the operating effect for the engine.

In accordance with one aspect of the invention, there is provided an engine comprising an engine cylinder including a spindle, a first pulley attached to the spindle and rotated in concert with the spindle, a supercharger including a receptacle having an air intake port, a first gear rotatably received and supported in the receptacle with a shaft, a second pulley attached to the shaft and rotated in concert with the shaft, a first coupling member engaged with the first pulley and the second pulley for allowing the second pulley and the first gear to be rotated and driven by the first pulley and the spindle with the first coupling member, and a turbine rotatably received and supported in the receptacle with an axle, and aligned with the air intake port of the receptacle, and coupled to the first gear for allowing the turbine to be rotated and driven by the first gear and for allowing the turbine to draw an air from ambient into the air intake port and into the cylinder.

A tensioning member is further provided and attached to the cylinder and engaged with the first coupling member for depressing and tensioning the first coupling member.

A third pulley is further provided and attached to the axle and rotated in concert with the axle, and a second coupling member is further provided and engaged with the first gear and the third pulley for coupling the turbine to the first gear and for allowing the turbine and the third pulley to be rotated and driven by the first pulley and the spindle.

A second gear is further provided and attached to the axle and rotated in concert with the axle, and engaged with the first gear for coupling the turbine to the first gear and for allowing the turbine to be rotated and driven by the first gear.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan and partial cross sectional view illustrating an engine in accordance with the present invention;

FIG. 2 is an enlarged partial cross sectional view of the engine;

FIG. 3 is a perspective view of the engine;

FIG. 4 is an enlarged partial perspective view of the engine;

FIG. 5 is a partial exploded view of the engine;

FIG. 6 is a perspective view illustrating a turbine for the engine;

FIG. 7 is a partial plan schematic view of the engine;

FIG. 8 is a cross sectional view of the engine taken along lines 8-8 of FIG. 7; and

FIG. 9 is a partial plan schematic view similar to FIG. 7, illustrating the other arrangement of the engine.

### DETAILED DESCRIPTION OF THE PREFERRED EMBODIMENT

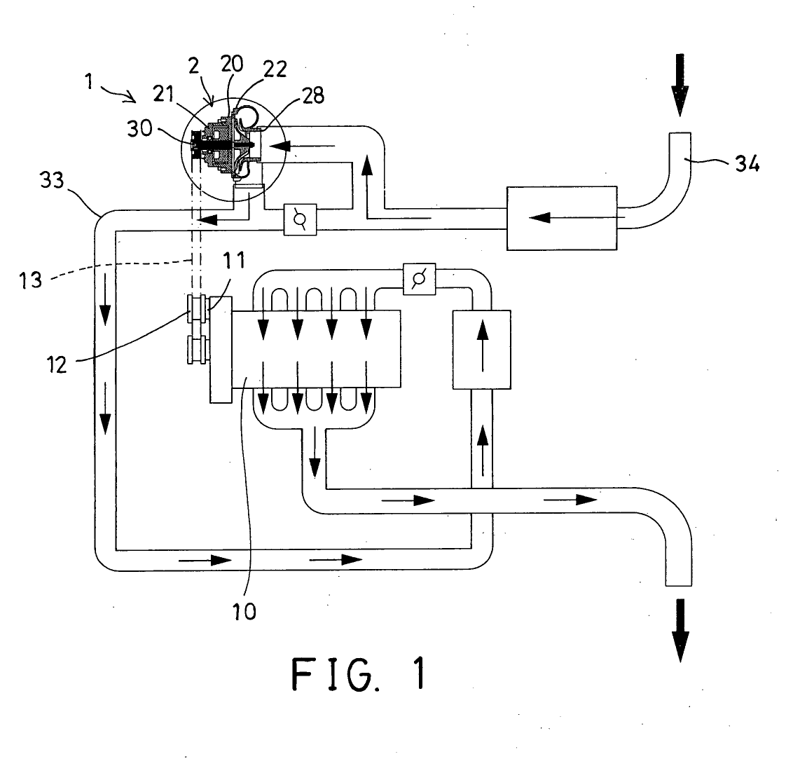

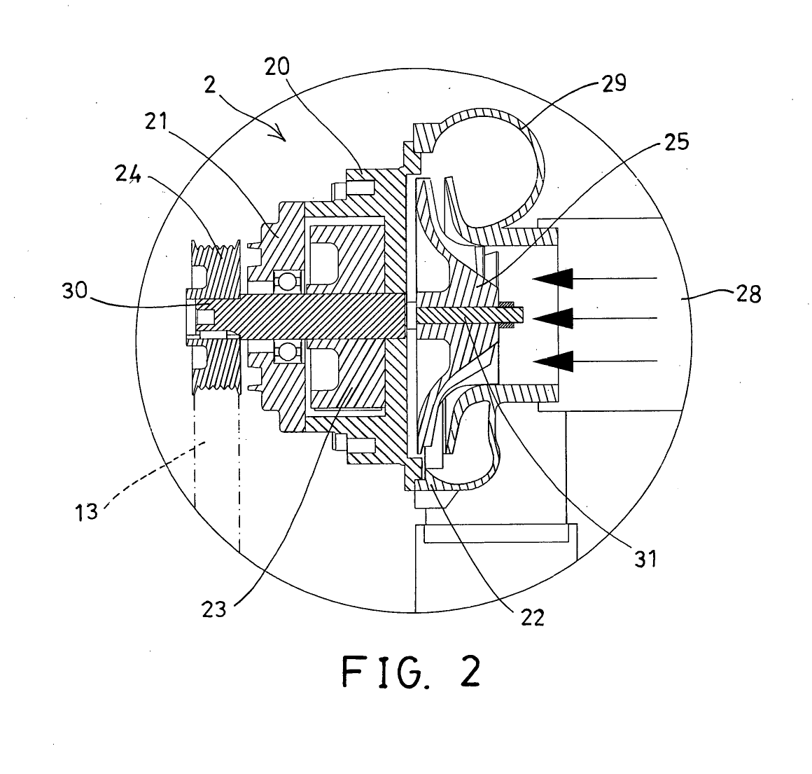

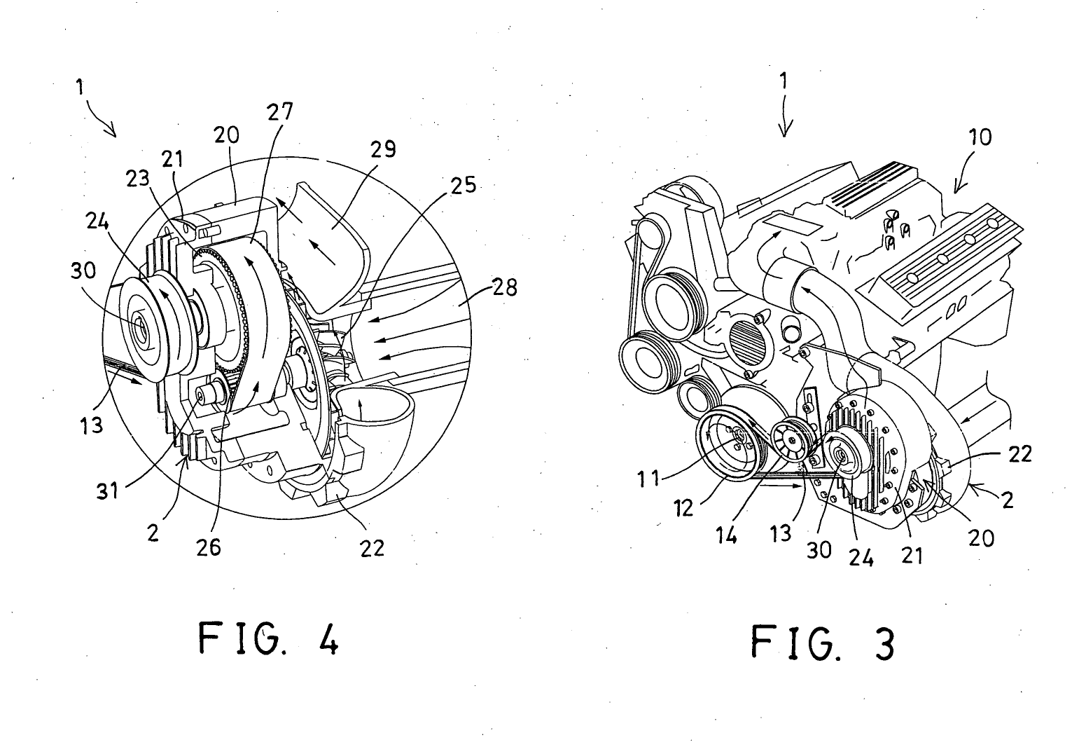

Referring to the drawings, and initially to FIGS. 1-3, an engine 1 in accordance with the present invention comprises an engine housing or cylinder 10 including an outlet spindle 11 coupled to a supercharger 2 for driving the supercharger 2, a rotary member 12, such as a gear or sprocket or pulley 12 attached to the outlet spindle 11 and rotated in concert with the outlet spindle 11 for coupling to or for engaging with a coupling member 13, such as a gear or chain or belt 13, and a tensioning member 14, such as a rotary member or pulley 14 attached to the cylinder 10 and engaged with the coupling member 13 for depressing or tensioning the coupling member 13 and for preventing the coupling member 13 from becoming loose after use.

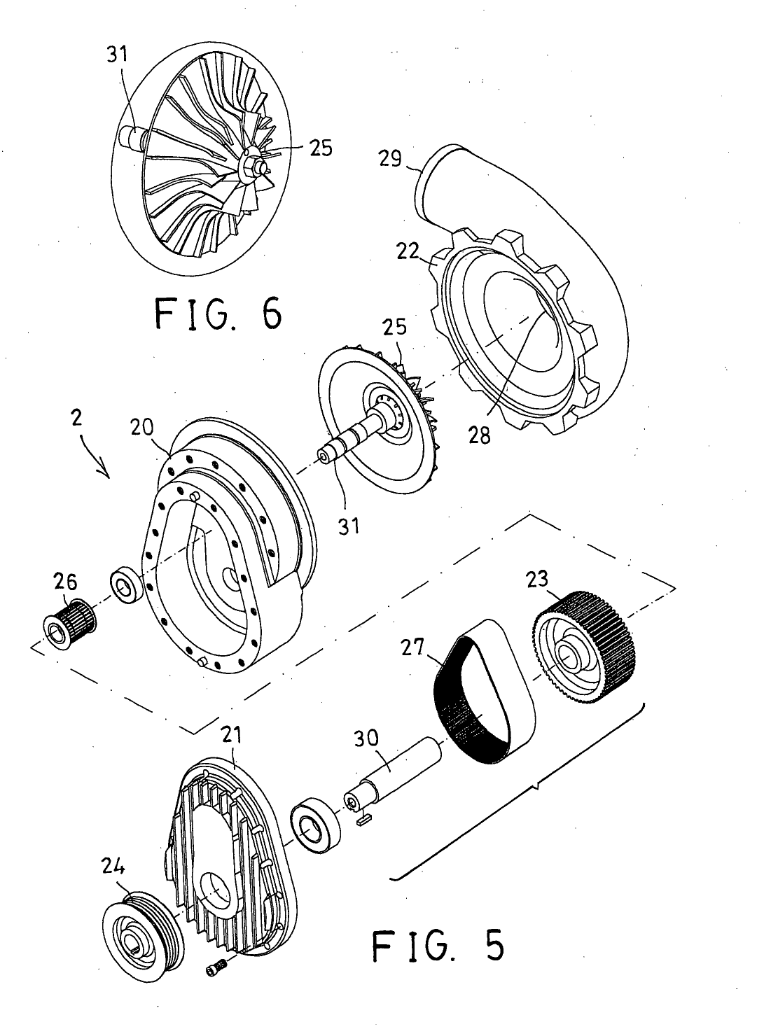

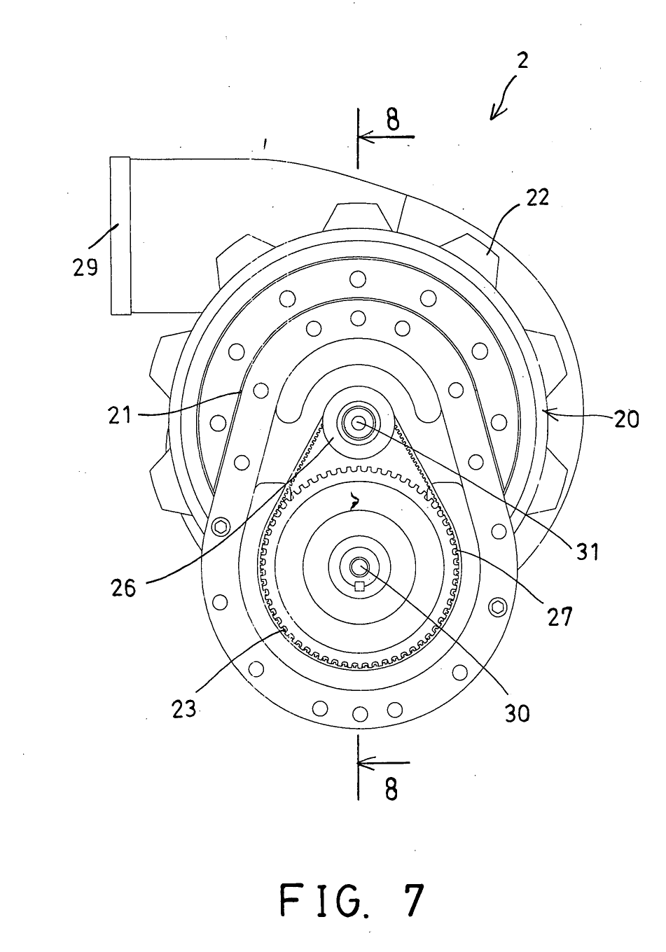

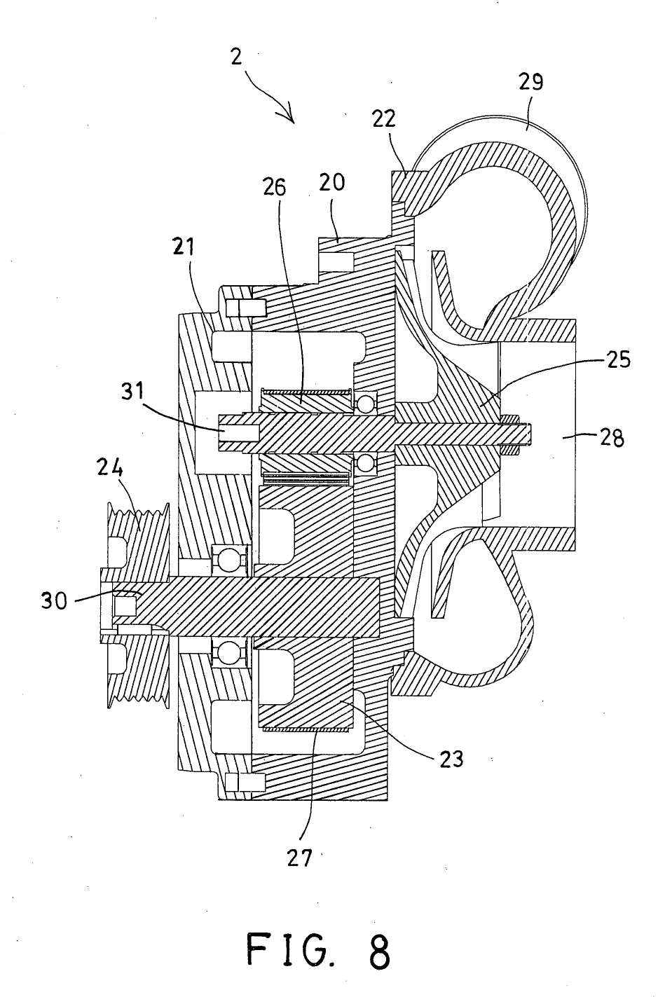

As shown in FIGS. 1-8, the supercharger 2 includes a main receptacle 20 having two end caps 21, 22 attached to the front and the rear portions of the receptacle 20, a gear 23 rotatably received and supported in the receptacle 20 with a shaft 30, and another rotary member 24, such as a gear or sprocket or pulley 24 attached to the shaft 30 and rotated in concert with the shaft 30 for coupling to or for engaging with the coupling member 13 and thus for allowing the gear 23 and the rotary member 24 to be rotated or driven by the rotary member 12 and the spindle 11. A turbine 25 is rotatably received and supported in the receptacle 20 with an axle 31, and a further rotary member 26, such as a gear or sprocket or pulley 26 attached to the axle 31 and rotated in concert with the axle 31.

A further coupling member 27, such as a gear or chain or belt 27 may be engaged with the gear 23 and the rotary member 26 for coupling the turbine 25 to the gear 23 and thus for allowing the turbine 25 to be rotated or driven by the rotary member 12 and the spindle 11 with the gear 23 and the rotary members 24, 26 and the coupling members 13, 27. The receptacle 20 of the supercharger 2 includes an air intake port 28 formed therein, such as formed in one of the end caps 22 and aligned with the turbine 25 for allowing the turbine 25 to draw the air from ambient into the air intake port 28, and includes an air guiding tube or passage 29 formed therein, such as also formed in the end cap 22 and communicating with the air intake port 28 (FIGS. 1, 2, 8) for allowing the air to be supercharged by the turbine 25.

As shown in FIG. 1, the air guiding tube or passage 29 of the receptacle 20 is coupled to the cylinder 10 with such as a pipe 33 for supplying or introducing the supercharged air into the cylinder 10 in order to increase the fuel consumption effect of the cylinder 10 and thus to increase the operating effect of the cylinder 10. The air intake port 28 may be coupled to an air inlet mouth 34 which is arranged and directed or faced toward the intake air when the vehicle is moving for allowing the air to be filled into the air inlet mouth 34 and the air intake port 28 and then supercharged by the turbine 25 and then supplied or introduced into the cylinder 10 such that the fuel consumption rate of the cylinder 10 may be suitably increased.

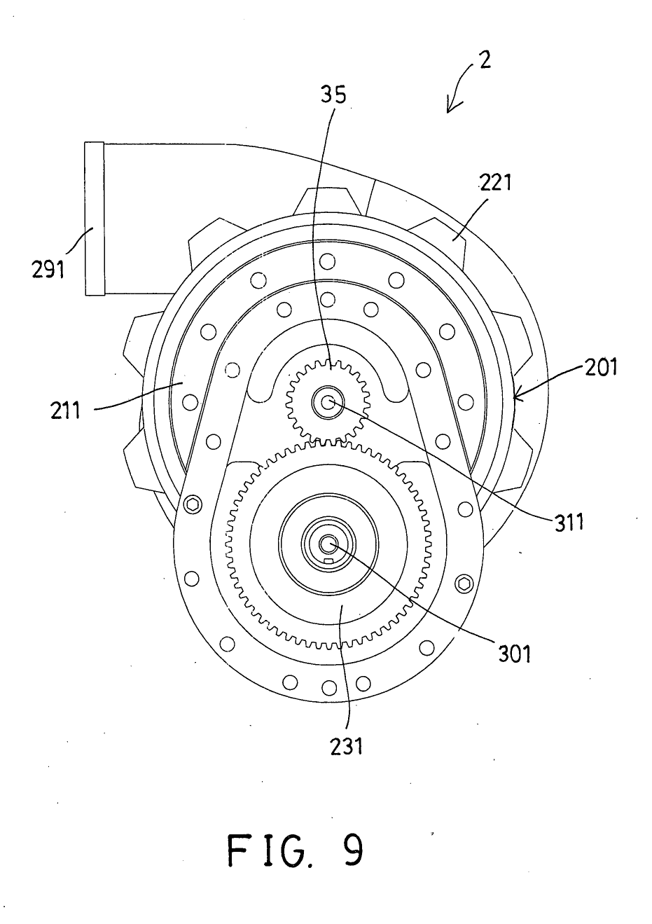

Alternatively, as shown in FIG. 9, the gear 231 may also be rotatably received and supported in the receptacle 201 or attached to the end caps 211, 221 with a shaft 301, and another rotary member 35, such as a sprocket or pulley or gear 35 is attached to the axle 311 and rotated in concert with the axle 311 for coupling to or for engaging with the rotary member or the gear 231, and thus for allowing the axle 311 to be rotated or driven by the rotary member 231 and the shaft 301 in order to supercharge the air and to supply the supercharged air out through the passage 291 of the receptacle 201. Instead of the rotary member 26 as shown in FIGS. 4-5 and 7-8, the gear 35 as shown in FIG. 9 is provided and attached to the axle 311 and directly engaged with the rotary member or the gear 231 for coupling the axle 311 to the shaft 301.

Accordingly, the engine in accordance with the present invention includes a supercharging device for supercharging the intake air and for supplying or introducing the supercharged air into the engine in order to increase the fuel consumption effect and thus to increase the operating effect for the engine.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An engine comprising:
an engine cylinder including a spindle,
a first pulley attached to said spindle and rotated in concert with said spindle,
a supercharger including a receptacle having an air intake port, a first gear rotatably received and supported in said receptacle with a shaft, a second pulley attached to said shaft and rotated in concert with said shaft,
a first coupling member engaged with said first pulley and said second pulley for allowing said second pulley and said first gear to be rotated and driven by said first pulley and said spindle with said first coupling member, and
a turbine rotatably received and supported in said receptacle with an axle, and aligned with said air intake port of said receptacle, and coupled to said first gear for allowing said turbine to be rotated and driven by said first gear and for allowing said turbine to draw an air from ambient into said air intake port and into said cylinder.

2. The engine as claimed in claim 1, wherein a tensioning member is attached to said cylinder and engaged with said first coupling member for depressing and tensioning said first coupling member.

3. The engine as claimed in claim 1, wherein a third pulley is attached to said axle and rotated in concert with said axle, and a second coupling member is engaged with said first gear and said third pulley for coupling said turbine to said first gear and for allowing said turbine to be rotated and driven by said first pulley and said spindle.

4. The engine as claimed in claim 1, wherein a second gear is attached to said axle and rotated in concert with said axle, and engaged with said first gear for coupling said turbine to said first gear and for allowing said turbine to be rotated and driven by said first gear.
